(19) United States
(12) Patent Application Publication
(10) Pub. No.: US 2026/0161410 A1
(43) Pub. Date: Jun. 11, 2026

(54) MEMORY DEVICE FORWARDING

(71) Applicant: Arm Limited, Cambridge (GB)

(72) Inventor: Kim Richard SCHUTTENBERG, Gilbert, AZ (US)

(21) Appl. No.: 18/971,476

(22) Filed: Dec. 6, 2024

(51) Int. Cl. G06F 9/38; G06F 9/30; G06F 9/32

(52) U.S. Cl. CPC G06F 9/3806; G06F 9/30043; G06F 9/321

(57) ABSTRACT

A data processing apparatus is provided in which receive circuitry receives a memory access instruction containing an indication of a target address. The target address is associated with one of a plurality of memory targets. Prediction circuitry performs a prediction of one of the plurality of memory targets to which the memory access instruction is associated, based on an address associated with the memory access instruction and forward circuitry forwards a memory access request based on the memory access instruction to the one of the plurality of memory targets.

### TECHNICAL FIELD

The present disclosure relates to data processing and particularly memory systems.

### DESCRIPTION

In some architectures, a number of memory devices may be provided and a memory access request could be directed towards any one of those devices. However, using a lookup table to work out which memory device to use (based on the access address) might be too slow.

### SUMMARY

Viewed from a first example configuration, there is provided a data processing apparatus comprising: receive circuitry configured to receive a memory access instruction comprising an indication of a target address, wherein the target address is associated with one of a plurality of memory targets; prediction circuitry configured to perform a prediction of one of the plurality of memory targets to which the memory access instruction is associated, based on an address associated with the memory access instruction; and forward circuitry configured to forward a memory access request based on the memory access instruction to the one of the plurality of memory targets.

Viewed from a second example configuration, there is provided a data processing method comprising: receiving a memory access instruction comprising an indication of a target address, wherein the target address is associated with one of a plurality of memory targets; performing a prediction of one of the plurality of memory targets to which the memory access instruction is associated, based on an address associated with the memory access instruction; and forwarding a memory access request based on the memory access instruction to the one of the plurality of memory targets.

Viewed from a third example configuration, there is provided a non-transitory computer-readable medium to storing computer-readable code for fabrication of a data processing apparatus comprising: receive circuitry configured to receive a memory access instruction comprising an indication of a target address, wherein the target address is associated with one of a plurality of memory targets; prediction circuitry configured to perform a prediction of one of the plurality of memory targets to which the memory access instruction is associated, based on an address associated with the memory access instruction; and forward circuitry configured to forward a memory access request based on the memory access instruction to the one of the plurality of memory targets.

Viewed from a fourth example configuration, there is provided a system comprising: the data processing apparatus, implemented in at least one packaged chip; at least one system component; and a board, wherein the at least one packaged chip and the at least one system component are assembled on the board.

Viewed from a fifth example configuration, there is provided a chip-containing product comprising the system, wherein the system is assembled on a further board with at least one other product component.

### BRIEF DESCRIPTION OF THE DRAWINGS

The present invention will be described further, by way of example only, with reference to embodiments thereof as illustrated in the accompanying drawings, in which:

FIG. 1 schematically illustrates a data processing apparatus in accordance with some examples;

FIG. 2 illustrates a hash lookup process for performing a prediction in accordance with some examples;

FIG. 3 schematically shows an expanded version of the data processing apparatus that allows for training, in accordance with some examples;

FIG. 4 illustrates a data processing method in accordance with some examples; and

FIG. 5 shows a further configuration in accordance with some examples.

### DESCRIPTION OF EXAMPLE EMBODIMENTS

Before discussing the embodiments with reference to the accompanying figures, the following description of embodiments is provided.

In accordance with one example configuration there is provided a data processing apparatus comprising: receive circuitry configured to receive a memory access instruction comprising an indication of a target address, wherein the target address is associated with one of a plurality of memory targets; prediction circuitry configured to perform a prediction of one of the plurality of memory targets to which the memory access instruction is associated, based on an address associated with the memory access instruction; and forward circuitry configured to forward a memory access request based on the memory access instruction to the one of the plurality of memory targets.

A data processing system may contain a number of different memories that can be accessed through a memory access instruction. The memory access instruction might indicate a target address of one of the memories (e.g. by specifying an offset, by referring to a register that contains an address, or by some combination of these and other techniques). In some cases, those memories may not be accessed through a cache but may instead be accessed directly from a load/store unit. In these situations, it is necessary to determine which of the memories the target address of a memory access instruction (e.g. the memory address that is to be accessed) is directed towards. This can be achieved by a direct lookup of the target address in, for instance, a lookup table. Such a lookup table can determine ranges of addresses and which of the memories is to be accessed for that range. In practice, however, this lookup process can be time consuming. Where it is necessary to access the data quickly, such a lookup (which may require a number of comparisons of numbers) could take too long. It might be tempting to resolve this problem by simply accessing every memory simultaneously and then multiplexing any results. However, this causes the unnecessary activation of the other memories (which consumes power). Additionally, a memory may be used for multiple purposes and in this case, unnecessarily activating a memory may inhibit it from participating in other actions. The present technique seeks to solve this problem by providing a prediction mechanism that predicts the memory that will be accessed. One of the inputs used for this prediction mechanism is an address associated with the memory access instruction. This could, for instance, be a program counter value of the memory access instruction or could be the target address itself. The prediction (not being a determination) can be made quickly, and the memory access instruction executed on the basis of the prediction. The memory access instruction can be forwarded (e.g. enacted upon) on the basis of a fast prediction without needing to wait for the address to be assessed and/or analysed.

In some examples, the prediction circuitry is configured to perform the prediction by performing a hashing algorithm that uses the address associated with the memory access instruction. A hash algorithm can be thought of as an algorithm that maps a larger input domain to a smaller output domain. In this case, there is no need for the hashing algorithm to be fair. So for example, outputs could be unevenly distributed across the output domain.

In some examples, the address associated with the memory access instruction is a program counter value; and the hashing algorithm takes a subset of bits of the program counter value as an input. Consequently, different inputs are provided for instructions that are grouped together in an instruction stream. By providing different inputs, different outputs might be expected for each of those inputs.

In some examples, the target address is relative to a reference point; and the hashing algorithm is configured to inhibit collisions for inputs in which only the reference point is different. The target address in the instruction may not be an absolute address might be instead be relative to the reference point. By inhibiting collisions in a situation where only the reference point is different, it is possible to more accurately select the correct memory device for a particular memory access. Where a collision occurs, it may be that the correct memory is still activated, in which case no harm is done and no correction is performed. It is more likely, however, that the collision will result in the wrong memory being activated and the memory access request being forwarded to the wrong memory. In this case, the same situation applies as for a wrong prediction (since, in practice, the prediction is simply providing the wrong answer). That is, determination circuitry detects the error (possibly in a later processing cycle) and a corrective action is taken.

In some examples, the hashing algorithm takes a pc relative bit as an input to indicate whether the target address is relative to a current program counter value. The current program counter value is also an address (specifically a memory address where the current program instruction is located). Consequently, a memory access that is relative to the current program counter value is likely accessing an instruction. Since instructions are primarily stored in certain memory devices—such as the instruction cache, it is possible to use this fact to more reliably activate the correct memory device (e.g. the instruction cache).

In some examples, the hashing algorithm takes an sp relative bit as an input to indicate whether the target address is relative to a current stack pointer value. Similarly to the above, the stack pointer is also an address (specifically a memory address where the stack is located). Consequently, a memory access that is relative to the stack pointer is likely accessing the stack. Since primarily current working data is stored in the stack, it is possible to use this fact to more reliably activate the correct memory device (e.g. the data cache).

In some examples, the hashing algorithm takes at least one characteristic bit as an input to indicate a characteristic of a register used to store the target address. The characteristic could, for instance, be whether the register that contains the memory address to be accessed has an odd number or an even number. In some architectures, the architectural registers might be split into different groups and hence the characteristic might be used to indicate whether the architectural register falls within one group or another group. By considering the characteristic, it is possible to provide some further variety in the generation of the hash and thereby further inhibit collisions from occurring. In some examples, a security state of the instruction may also be used. A further input that may be used is the privilege of the instruction. For instance, these inputs could be added to the hash (prior to any lookup being performed). This can be used to help prevent secure and non-secure (or privileged and unprivileged code) from sharing a hash.

When the address space identifier is changed (e.g. when the active virtual machine or active user application changes), predictions that have been set for the same security level are reset to a default (e.g. no prediction). This makes it possible to protect predictions from being modified between address space identifiers of the same security level.

In some examples, the data processing apparatus comprises: storage circuitry configured to store a plurality of mappings from hashes to target predictions, wherein each of the target predictions relates to one of the plurality of memory targets. Having determined the hash from the various inputs, the determined hash is compared to other hashes in the storage circuitry. Each of the hashes has a corresponding memory that was accessed and the matching hash's specified memory then has the memory access request forwarded to it. For instance, if the generated hash is the number 75928 then the memory access request will be forwarded to the memory that is mapped to the hash 75928 in the storage circuitry.

In some examples, each of the mappings is associated with a confidence value; and the confidence value is used to determine whether the target predictions should be used. There may not be a perfect mapping between hashes and the activation of particular memories. For instance, multiple instructions might produce the same hash, each of which activates a different memory. In some cases, the same instruction could activate different memories depending on its execution. For these reasons, a confidence value can be provided that indicates a degree of certainty that a particular memory will be activated for a given hash. Where the certainty is low, the prediction may not be followed. The certainty can be increased by the prediction being correct (whether it is followed or not) and the certainty can be decreased by the prediction being incorrect. There are a number of ways in which a confidence can be measured, and the exact technique is beyond the scope of the present disclosure. But one way of measuring the certainty is by a saturating two-bit counter.

In some examples, the data processing apparatus comprises: training circuitry configured to perform training to produce the mappings from hashes to target predictions. The training circuitry is used to train the system to make predictions. This can be achieved by watching which memories are activated in response to each memory access request and looking for repeat occurrences. As the number of times a particular memory is accessed or activated in response to a particular memory access instruction (or more specifically the hash from that memory access instruction), the training circuitry will increase the confidence associated with the mapping from that hash to the memory. Once the confidence reaches a particular value, further instances of the memory access instruction (or the hash) will cause the specified memory to be activated and for the memory access instruction to be forwarded to that memory.

In some examples, the data processing apparatus comprises: determination circuitry configured to perform a determination of which of the plurality of memory targets the target address is associated, based on the target address, wherein the prediction is completed before the determination is completed. In addition to performing the prediction so that the memory access instruction can be forwarded (e.g. executed) in respect of the selected memory target, a slower definitive determination is made as to which of the memory targets should have been used. This determination might not resolve until a later processor cycle and therefore it is expected for the prediction to be completed first so that the memory access instruction can be executed quickly.

In some examples, in response to the determination differing from the prediction, the determination circuitry is configured to cause a corrective action to be taken. Since the prediction is only a prediction rather than a determination, it could be wrong. Furthermore, since the determination may not be completed until a later processing cycle, it is possible that this will not be known until a later time. A corrective action is therefore taken to correct the fact that the memory access instruction was forwarded to a memory target other than the one that it should have been forwarded to.

In some examples, the corrective action comprises at least one of: replaying the memory access instruction and correcting the prediction. There are a number of forms that the corrective action can take. However, in these examples, the corrective action causes the memory access instruction to be replayed (and thereby sent to the now determined correct memory target). In addition, the prediction is corrected (e.g. by adjusting a confidence associated with the mapping for the prediction) so that its use will be discouraged. This adjustment of the confidence may also cause the confidence associated with the correct memory target to be increased.

In some examples, the plurality of memory targets include SRAMs. SRAM (static random access memory) stores data permanently provided power is provided (which differs from dynamic random access memory, which must be repeatedly refreshed). SRAM is typically used for fast memories such as caches due to its faster response time as compared to DRAM.

In some examples, there is a two cycle load-use period for executing the memory access instruction. In these examples, the execution of the memory access instruction (i.e. from the time that it is issued) to the time that the data is returned is two processor cycles or less.

In some examples, the plurality of memory targets include one or more of: a data tightly coupled memory, an instruction tightly coupled memory, an instruction cache, and a data side cache, and an external peripheral bus. The tightly coupled memories may cover a fixed, known, span of addresses. Consequently, whether data is found within a tightly coupled memory is known and the access time to retrieve data from that memory is therefore deterministic. In the case of the caches, the span of addresses may not be fixed and consequently whether a particular data item is present or not may not be known ahead of time. The time taken to access data from a cache is therefore nondeterministic because a different time will be required to obtain the data if the data is present than if it is not present (and must therefore be retrieved from elsewhere in the memory hierarchy).

Particular embodiments will now be described with reference to the figures.

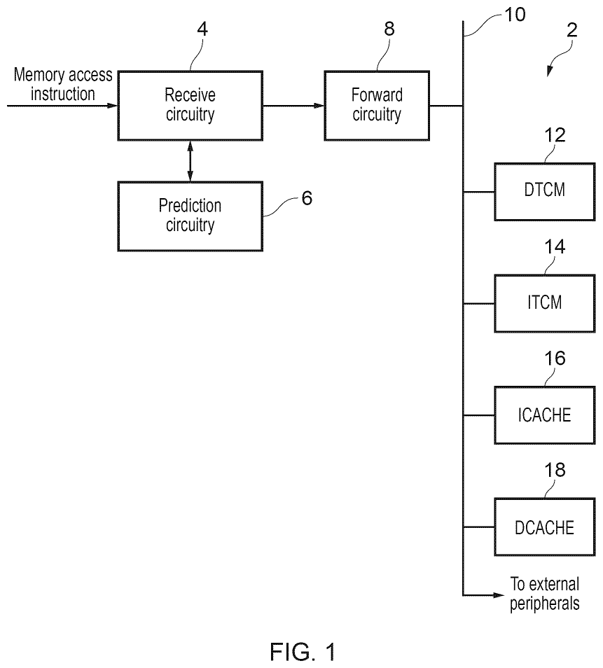

FIG. 1 illustrates an example of a data processing apparatus 2 in accordance with some examples. Here, a memory access instruction is issued from the core of a CPU and is received by receive circuitry 4. The memory access instruction may be as write instruction or a read instruction and targets a particular memory location. The memory location may be explicitly specified in the instruction or the instruction might instead provide a register identifier where the address to be accessed in stored in the specified register. Regardless, the memory address will be assigned to one of several memories (e.g. SRAMs) 12, 14, 16, 18, or an external peripheral. The memories 12, 14, 16, 18 are accessible via a bus 10. Arbitration may occur on the bus 10 between the memories 12, 14, 16, 18 and/or different sources of access. For instance, multiple data processing apparatus (each of which generates memory access instructions) may each access the bus 10.

Each of the memories/SRAMs 12, 14, 16, 18 performs a different function. The exact purpose of these memories and the precise mapping of addresses to memories 12, 14, 16, 18 is not material to the present invention. However, it may be noted that the mapping of addresses to memories may vary over time.

In order to determine which of the memories 12, 14, 16, 18 to activate and to forward the request to, it is necessary to know which of the memories 12, 14, 16, 18 is targeted by the memory access instruction. While it may be possible to use a lookup table to determine this, a lookup table may take too long-particularly if a fast response is expected. In this architecture, a two cycle load-use is expected (measured according to a pointer chase). That is, from the time of receiving the instruction, it is expected for the data to be returned within two processor cycles. Consequently, the use of a lookup table is too slow and hence prediction circuitry 6 is used.

The prediction circuitry 6 is used to determine which of the memories/SRAMs 12, 14, 16, 18 will be accessed from a particular instruction. This is achieved based on an address that is associated with the instruction—for instance, this could be the program counter value of the instruction or could be targeted memory address. Importantly, however, the prediction is a prediction rather than a determination, meaning that the prediction could be incorrect. In these examples, the prediction is based on a past behaviour of the instruction and in particular which of the memories 12, 14, 16, 18 has been activated for a previous invocation of the instruction.

Having determined the prediction, via the prediction circuitry 6, the request is then executed in respect of the predicted memory. For instance, a memory access request corresponding to the memory access instruction is forwarded to the predicted memory via the forward circuitry 8.

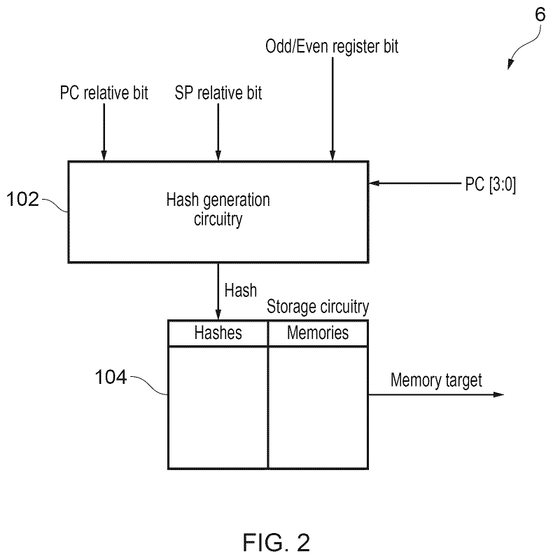

FIG. 2 provides an example of the prediction circuitry 6. In this example, the prediction circuitry 6 includes hash generation circuitry 102, which is used to generate a hash. A number of inputs are taken, in this example, to generate the hash. For instance, the hash generation circuitry 102 takes as an input four bits from the program counter value ([3:0]). These bits need not be the least significant bits. For instance, if program counter values are the virtual addresses where instructions are stored (rather than the most significant bits of those addresses) then for instructions of size N, it might be appropriate to take bits [log₂(N)+3:log₂(N)]. By taking bits of the program counter value as an input to the hashing algorithm, instructions that are closely related to each other (spatially) can be expected to have a different input and therefore are more likely to produce a different hash. Thus, different hashes would be expected for instructions that are close to each other.

A further input that can be provided is a characteristic of any register used to store the memory access address—in this example, whether the register has an odd or even number is considered. This adds further variety to the inputs to the hashing circuitry 102 and therefore can be used to provide a wider variation in hashes that are produced.

A further input that can be provided is whether the target address is relative to a stack pointer and/or whether the target address is relative to the program counter value. One reason to include these inputs is that whether a target address (the address being accessed in the memory access instruction) is relative to a program counter value or a stack pointer value can be indicative of the type of memory that will be accessed. For instance, if the address is relative to a program counter value then it is likely that another program counter value is being accessed. In this case, it is likely that an instruction is being accessed and consequently, memories that store instructions (e.g. ITCM 14 and ICACHE 16) are more likely to be targeted by the memory access instruction. Similarly, if the target address is relative to a stack pointer value then it is likely that the stack is being accessed. Since the stack is typically used to store data, it is likely that a data item is being accessed meaning that one of the data memories (DTCM 12 or DCACHE 18) are going to be accessed. By considering such inputs to the hashing algorithm, it is possible to produce hashes that more accurately reflect the memory that is likely to be accessed.

There are a number of ways in which the hash can be produced from the inputs. In some examples, the inputs are simply concatenated together, in this example to provide a 7-bit number, which is the hash. Other techniques may use additional (or other inputs).

Still further inputs that can be considered, either as an input to the hashing algorithm or after the hashing algorithm, include a security state and/or privilege level of the instruction that generated the memory access instruction. This can be used to help prevent secure and non-secure (or privileged and unprivileged code) from sharing a hash.

Having produced the hash, the hash is used to access storage circuitry 104 to search for any matching entries. In particular, the storage circuitry 104 stores mappings between hashes and the memories 12, 14, 16, 18 that are activated. Thus, given a particular hash for a current memory access instruction, it is possible to determine if there is a corresponding listed memory or memories that should be activated for the memory access instruction to be forwarded towards.

It is possible that no entry will be found for the generated hash. In this situation, it is possible for one of the memories 12, 14, 16, 18 to be selected at random, for one of the memories to be selected based on which of the memories 12, 14, 16, 18 was most recently accessed (taking advantage of temporal locality), for one of the memories 12, 14, 16, 18 to be selected based on size (assuming that each memory address is equally likely to be accessed) or for one of the memories 12, 14, 16, 18 to be selected based on other criteria.

In some cases, the selection of an entry may be based on a confidence value associated with that prediction. For instance, there may be multiple entries for a hash value, with each entry having a different confidence value and a different one of the memories 12, 14, 16, 18 identified. An entry with the highest confidence may be selected. Where multiple entries have the same highest confidence, or where none of the entries have a confidence above a threshold, one of the above techniques will be used. The precise mechanism used to provide confidence is immaterial to the present technique. However, a correspondence between the determination made by the determination circuitry 302 and the prediction made by the prediction circuitry 6 may be used to adjust the confidence upwards (if correct) and downwards (if incorrect). If the resulting new confidence hits some lower threshold, then it may be removed. Meanwhile, new entries are added to the storage circuitry 104 for newly made predictions that do not already exist for a particular hash value.

In other examples, only a single value may be provided for each hash in the storage circuitry 104. In this case, values are added to the storage circuitry 104 when a prediction is made for a hash value and there is no existing entry for that hash value. Deallocation occurs, as above, if the confidence value for that prediction drops below a lower threshold. Meanwhile the confidence value is increased if the determination matches the prediction and lowered if the determination contradicts the prediction.

In still other examples, every hash value will produce a prediction and thus, no allocation or deallocation occurs. Instead, the confidence for that prediction may be altered over time, and the prediction itself may be altered over time.

Other prediction mechanisms are also usable.

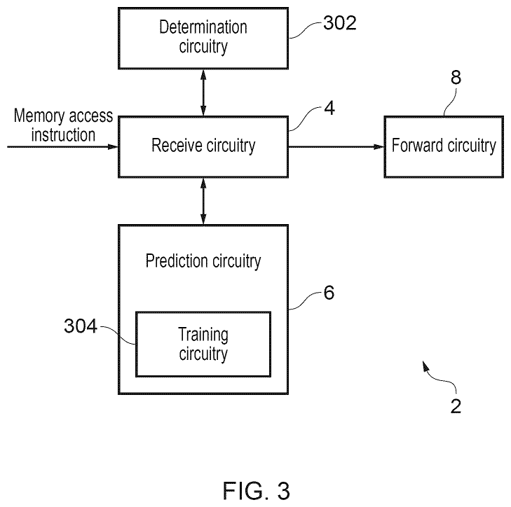

FIG. 3 shows an expanded example of the data processing apparatus 2 shown in FIG. 1. In this example, the data processing apparatus 2 is expanded to include determination circuitry 302 and training circuitry 304.

As previously explained, the prediction circuitry 6 quickly produces a prediction of the memories 12, 14, 16, 18 that will be accessed. However, as a consequence of this being a prediction, it is possible for it to be wrong. Determination circuitry 302 is therefore provided to make a slower determination of which memories 12, 14, 16, 18 should be accessed from the target memory address (e.g. using a slower lookup table). This determination can then be contrasted with the prediction in order to determine whether the prediction was correct. If not, some corrective action can be taken such as replaying the memory access instruction with the additional information provided by the determination circuitry 302, stalling the pipeline (e.g. the execution of other instructions or at least other memory access instructions) and correcting the prediction in the prediction circuitry 6.

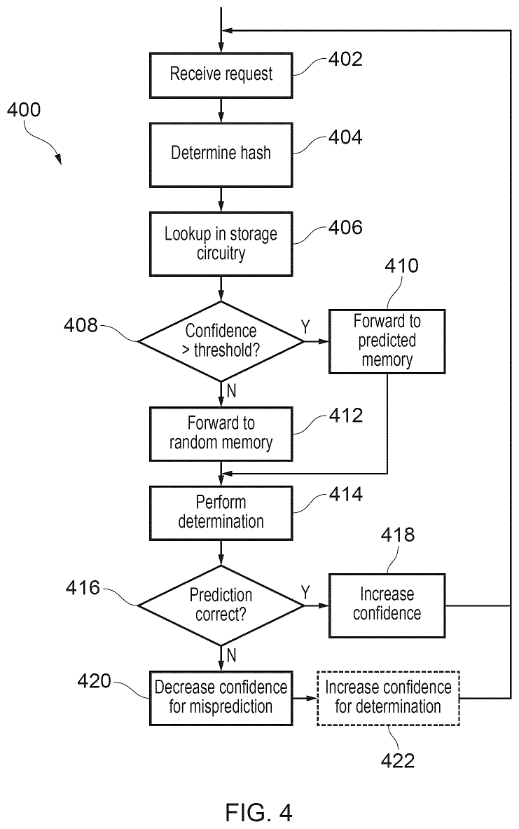

FIG. 4 illustrates a method of data processing in accordance with some examples in the form of a flowchart 400. The process begins at step 402 where a memory access request is received. At a step 404, a hash is determined based on (at least in part) one or more addresses associated with the memory access request. At a step 406, the hash is looked up in the storage circuitry. At a step 408, it is determined if there is a single entry where the confidence is greater than a given confidence threshold. If so, then at step 410, the memory access request is forwarded (e.g. by the forward circuitry 8) to the predicted memory. Otherwise, at step 412, the request is forwarded (again by the forward circuitry 8) to a random memory. If there were multiple entries of a highest confidence, then the random memory is selected from those memories having the highest confidence. In any event, with the request having been forwarded based on a prediction (or randomly), a determination is made at step 414. This determination will take longer to produce a result than the prediction that is made. However, at step 416, it is determined whether the prediction was correct or not. If correct, then the confidence of that prediction is increased at step 418 and the storage circuitry 104 is updated with the new confidence for the prediction. The process then returns to the start. If the prediction was not correct, then the confidence value associated with the misprediction in the storage circuitry 104 (if there is one) is decreased at step 420. The confidence may become so low that the entry is deleted. At a step 422, the confidence for the determination may be increased (if it is in the storage circuitry 104) or added (if it is not present). For instance, having determined that a particular memory will be accessed, if there is an existing entry in the storage circuitry for that particular memory, the confidence associated with that memory can be increased (since it is known with more certainty that this memory will be accessed). If no such entry for that particular memory exists, then a new entry can be created (representing the fact that this is a memory that could be accessed).

This step (422) is optional and may depend on the confidence scheme being performed. Where only a single value is maintained for each hash, this step may be foregone. In any event, the process then returns to the start.

Note that although step 412 involves forwarding the request to a random memory, it could alternatively forward the request to all memories or could forward the request to no memories.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, System Verilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Concepts described herein may be embodied in a system comprising at least one packaged chip. The system described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

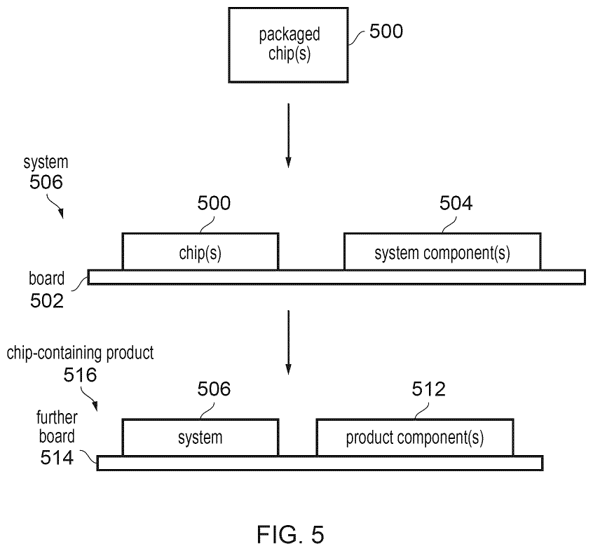

As shown in FIG. 5, one or more packaged chips 500, with the apparatus described above implemented on one chip or distributed over two or more of the chips, are manufactured by a semiconductor chip manufacturer. In some examples, the chip product 500 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 500 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 500 are assembled on a board 502 together with at least one system component 504 to provide a system 506. For example, the board may comprise a printed circuit board. The board substrate may be made of any of a variety of materials, e.g. plastic, glass, ceramic, or a flexible substrate material such as paper, plastic or textile material. The at least one system component 504 comprise one or more external components which are not part of the one or more packaged chip(s) 500. For example, the at least one system component 504 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 516 is manufactured comprising the system 506 (including the board 502, the one or more chips 500 and the at least one system component 504) and one or more product components 512. The product components 512 comprise one or more further components which are not part of the system 506. As a non-exhaustive list of examples, the one or more product components 512 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 506 and one or more product components 512 may be assembled on to a further board 514.

The board 502 or the further board 514 may be provided on or within a device housing or other structural support (e.g. a frame or blade) to provide a product which can be handled by a user and/or is intended for operational use by a person or company.

The system 506 or the chip-containing product 516 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

The invention can also be set out as follows:
1. A data processing apparatus comprising:
   receive circuitry configured to receive a memory access instruction comprising an indication of a target address, wherein the target address is associated with one of a plurality of memory targets;
   prediction circuitry configured to perform a prediction of one of the plurality of memory targets to which the memory access instruction is associated, based on an address associated with the memory access instruction; and
   forward circuitry configured to forward a memory access request based on the memory access instruction to the one of the plurality of memory targets.
2. The data processing apparatus according to any preceding clause, wherein
   the prediction circuitry is configured to perform the prediction by performing a hashing algorithm that uses the address associated with the memory access instruction.
3. The data processing apparatus according to clause 2, wherein
   the address associated with the memory access instruction is a program counter value; and
   the hashing algorithm takes a subset of bits of the program counter value as an input.
4. The data processing apparatus according to any one of clauses 2-3, wherein
   the target address is relative to a reference point; and
   the hashing algorithm is configured to inhibit collisions for inputs in which only the reference point is different.
5. The data processing apparatus according to any one of clauses 2-4, wherein
   the hashing algorithm takes a pc relative bit as an input to indicate whether the target address is relative to a current program counter value.
6. The data processing apparatus according to any one of clauses 2-5, wherein
   the hashing algorithm takes an sp relative bit as an input to indicate whether the target address is relative to a current stack pointer value.
7. The data processing apparatus according to any one of clauses 2-6, wherein
   the hashing algorithm takes at least one characteristic bit as an input to indicate a characteristic of a register used to store the target address.
8. The data processing apparatus according to any one of clauses 2-7, comprising:
   storage circuitry configured to store a plurality of mappings from hashes to target predictions, wherein
   each of the target predictions relates to one of the plurality of memory targets.
9. The data processing apparatus according to clause 8, wherein
   each of the mappings is associated with a confidence value; and
   the confidence value is used to determine whether the target predictions should be used.
10. The data processing apparatus according to any preceding clause, comprising:
   training circuitry configured to perform training to produce the mappings from hashes to target predictions.
11. The data processing apparatus according to any preceding clause, comprising:
   determination circuitry configured to perform a determination of which of the plurality of memory targets the target address is associated, based on the target address, wherein
   the prediction is completed before the determination is completed.
12. The data processing apparatus according to clause 11, wherein
   in response to the determination differing from the prediction, the determination circuitry is configured to cause a corrective action to be taken.
13. The data processing apparatus according to clause 12, wherein
   the corrective action comprises at least one of: replaying the memory access instruction, correcting the prediction, and stalling execution of one or more instructions.
14. The data processing apparatus according to any preceding clause, wherein
   the plurality of memory targets include SRAMs.
15. The data processing apparatus according to any preceding clause, wherein
   there is a two cycle load-use period for executing the memory access instruction.
16. The data processing apparatus according to any preceding clause, wherein
   the plurality of memory targets include one or more of: a data tightly coupled memory, an instruction tightly coupled memory, an instruction cache, and a data side cache, and an external peripheral bus.
17. A data processing method comprising:
   receiving a memory access instruction comprising an indication of a target address, wherein the target address is associated with one of a plurality of memory targets;
   performing a prediction of one of the plurality of memory targets to which the memory access instruction is associated, based on an address associated with the memory access instruction; and
   forwarding a memory access request based on the memory access instruction to the one of the plurality of memory targets.
18. A non-transitory computer-readable medium to storing computer-readable code for fabrication of a data processing apparatus comprising:
   receive circuitry configured to receive a memory access instruction comprising an indication of a target address, wherein the target address is associated with one of a plurality of memory targets;
   prediction circuitry configured to perform a prediction of one of the plurality of memory targets to which the memory access instruction is associated, based on an address associated with the memory access instruction; and
   forward circuitry configured to forward a memory access request based on the memory access instruction to the one of the plurality of memory targets.
19. A system comprising:
   the data processing apparatus of any one of clauses 1-16, implemented in at least one packaged chip;
   at least one system component; and
   a board,
   wherein the at least one packaged chip and the at least one system component are assembled on the board.
20. A chip-containing product comprising the system of clause 19, wherein the system is assembled on a further board with at least one other product component.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes, additions and modifications can be effected therein by one skilled in the art without departing from the scope and spirit of the invention as defined by the appended claims. For example, various combinations of the features of the dependent claims could be made with the features of the independent claims without departing from the scope of the present invention.

We claim:

1. A data processing apparatus comprising:
receive circuitry configured to receive a memory access instruction comprising an indication of a target address, wherein the target address is associated with one of a plurality of memory targets;
prediction circuitry configured to perform a prediction of one of the plurality of memory targets to which the memory access instruction is associated, based on an address associated with the memory access instruction; and
forward circuitry configured to forward a memory access request based on the memory access instruction to the one of the plurality of memory targets.

2. The data processing apparatus according to claim 1, wherein
the prediction circuitry is configured to perform the prediction by performing a hashing algorithm that uses the address associated with the memory access instruction.

3. The data processing apparatus according to claim 2, wherein
the address associated with the memory access instruction is a program counter value; and
the hashing algorithm takes a subset of bits of the program counter value as an input.

4. The data processing apparatus according to claim 2, wherein
the target address is relative to a reference point; and
the hashing algorithm is configured to inhibit collisions for inputs in which only the reference point is different.

5. The data processing apparatus according to claim 2, wherein
the hashing algorithm takes a pc relative bit as an input to indicate whether the target address is relative to a current program counter value.

6. The data processing apparatus according to claim 2, wherein
the hashing algorithm takes an sp relative bit as an input to indicate whether the target address is relative to a current stack pointer value.

7. The data processing apparatus according to claim 2, wherein
the hashing algorithm takes at least one characteristic bit as an input to indicate a characteristic of a register used to store the target address.

8. The data processing apparatus according to claim 2, comprising:
storage circuitry configured to store a plurality of mappings from hashes to target predictions, wherein
each of the target predictions relates to one of the plurality of memory targets.

9. The data processing apparatus according to claim 8, wherein
each of the mappings is associated with a confidence value; and
the confidence value is used to determine whether the target predictions should be used.

10. The data processing apparatus according to claim 1, comprising:
training circuitry configured to perform training to produce the mappings from hashes to target predictions.

11. The data processing apparatus according to claim 1, comprising:
determination circuitry configured to perform a determination of which of the plurality of memory targets the target address is associated, based on the target address, wherein
the prediction is completed before the determination is completed.

12. The data processing apparatus according to claim 11, wherein
in response to the determination differing from the prediction, the determination circuitry is configured to cause a corrective action to be taken.

13. The data processing apparatus according to claim 12, wherein
the corrective action comprises at least one of: replaying the memory access instruction, correcting the prediction, and stalling execution of one or more instructions.

14. The data processing apparatus according to claim 1, wherein
the plurality of memory targets include SRAMs.

15. The data processing apparatus according to claim 1, wherein
there is a two cycle load-use period for executing the memory access instruction.

16. The data processing apparatus according to claim 1, wherein
the plurality of memory targets include one or more of: a data tightly coupled memory, an instruction tightly coupled memory, an instruction cache, and a data side cache, and an external peripheral bus.

17. A data processing method comprising:
receiving a memory access instruction comprising an indication of a target address, wherein the target address is associated with one of a plurality of memory targets;
performing a prediction of one of the plurality of memory targets to which the memory access instruction is associated, based on an address associated with the memory access instruction; and
forwarding a memory access request based on the memory access instruction to the one of the plurality of memory targets.

18. A non-transitory computer-readable medium to storing computer-readable code for fabrication of a data processing apparatus comprising:
receive circuitry configured to receive a memory access instruction comprising an indication of a target address, wherein the target address is associated with one of a plurality of memory targets;
prediction circuitry configured to perform a prediction of one of the plurality of memory targets to which the memory access instruction is associated, based on an address associated with the memory access instruction; and
forward circuitry configured to forward a memory access request based on the memory access instruction to the one of the plurality of memory targets.

19. A system comprising:
the data processing apparatus of claim 1, implemented in at least one packaged chip;
at least one system component; and
a board,
wherein the at least one packaged chip and the at least one system component are assembled on the board.

20. A chip-containing product comprising the system of claim 19, wherein the system is assembled on a further board with at least one other product component.
